(19) United States
(12) Patent Application Publication
(10) Pub. No.: US 2023/0236133 A1
(43) Pub. Date: Jul. 27, 2023

(54) Drug Capsule Appearance Inspection Device

(71) Applicant: SLTG CORPORATION, Seoul (KR)

(72) Inventor: Ku Hyun Lee, Goyang-si Gyeonggi-do (KR)

(21) Appl. No.: 18/157,181

(22) Filed: Jan. 20, 2023

(30) Foreign Application Priority Data
Jan. 21, 2022 (KR) 10-2022-0009038

(51) Int. Cl. G01N 21/90

(52) U.S. Cl. CPC G01N 21/9009; G01N 2201/0461

(57) ABSTRACT

A drug capsule appearance inspection device is provided having a simplified structure so as to have the effect of inspecting the appearance of drug capsules more rapidly and efficiently and reducing costs. To this end, the device includes: a guide plate (10) having a plurality of capsule accommodating grooves (11) formed therein so that drug capsules (P) can be accommodated; and a bottom friction surface (20) that allows the drug capsules (P) to rotate by friction when the guide plate (10) moves horizontally.

### BACKGROUND OF THE INVENTION

The present invention relates to a drug capsule appearance inspection device, and to a capsule appearance inspection device having an improved structure so that an appearance inspection for screening drug-filled capsule products can be efficiently performed.

In general, drugs such as tablets and capsules are finally shipped as products after undergoing an appearance inspection process by means of an inspection device. During the appearance inspection process, defects such as surface defects, corner defects, and engraving defects are inspected. Small items other than drugs may require appearance inspection just like drugs.

In general, a device for inspecting the appearance of small articles employs a method of photographing a small article such as a drug such as a tablet or a capsule with a camera so as to obtain an image of the surface thereof and analyzing the image to determine whether there is a defect.

The conventional small article appearance inspection device includes two rotation drums, which are provided in a vertical structure and have suction grooves or receiving grooves formed at regular intervals around the rotation drums so as to adsorb small articles, wherein an appearance inspection is performed by adsorbing an object to be appearance-inspected on the circumference of one of the drums, rotating the drums, photographing one side of the exterior of the object, and then transferring the small object to the other rotating drum and photographing the opposite side of the exterior of the object.

In addition to the adsorption type rotation drum type appearance inspection device, a non-adsorption type appearance inspection device using a transfer roller has also been developed.

However, the conventional capsule inspection devices have problems such as an increase in inspection costs due to a complicated configuration, and repair costs in case of device failure.

### SUMMARY OF THE INVENTION

The present invention has been derived to solve these problems and has an object to provide a capsule appearance inspection device having a simplified structure so as to inspect the appearance of drug capsules more rapidly and efficiently and reduce costs.

In order to achieve the above object, an appearance inspection device, includes: a guide plate having a plurality of capsule accommodating grooves formed therein so that drug capsules can be accommodated; and a bottom friction surface that allows the drug capsules to rotate by friction when the guide plate moves horizontally.

In addition, the capsule accommodating grooves have an inclination of a predetermined angle.

According to the present invention, the capsule appearance inspection device has a simplified structure so as to provide the effect of inspecting the appearance of drug capsules more rapidly and efficiently and reducing costs.

In particular, by forming the capsule accommodating grooves at a certain angle, there is an advantage in that rotation according to the friction with the bottom friction surface can be achieved more smoothly.

### BRIEF DESCRIPTION OF THE DRAWINGS

FIG. 1 is a diagram showing an appearance structure of a capsule appearance inspection device according to an embodiment of the present invention.

FIG. 2 is a plan view of the inspection device of the present invention.

FIG. 3 is an enlarged view of part A of FIG. 2.

FIG. 4 is a cross-sectional structural diagram of the inspection device of the present invention.

FIG. 5 is a diagram showing a use state of the inspection device of the present invention.

FIG. 6 is a cross-sectional view showing the movement of a capsule in the present invention.

FIG. 7 is a detailed view of main parts according to another embodiment of the present invention.

FIG. 8 is a plan view of an inspection device according to still another embodiment of the present invention.

### DETAILED DESCRIPTION FOR CARRYING OUT THE INVENTION

According to modes for carrying out the present invention, a drug capsule appearance inspection device includes: a guide plate 10 having a plurality of capsule accommodating grooves 11 formed therein so that drug capsules P can be accommodated; and a bottom friction surface 20 that allows the drug capsules P to rotate by friction when the guide plate 10 moves horizontally.

Hereinafter, embodiments of the present invention will be described in detail with reference to the accompanying drawings.

Embodiments of the present invention may be modified in various forms, and the scope of the present invention should not be construed as being limited to the embodiments described in detail below. The embodiments are provided to more completely explain the present invention to those of ordinary skill in the art.

Accordingly, the shape of the components expressed in the drawings may be exaggerated to emphasize a clearer description. It should be noted that the same configuration in each drawing is sometimes illustrated with the same reference numerals. In addition, detailed descriptions of functions and configurations of known technologies that may unnecessarily obscure the gist of the present invention may be omitted.

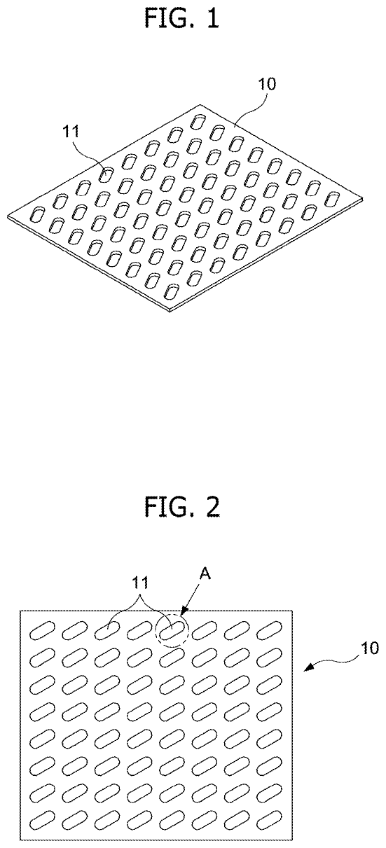

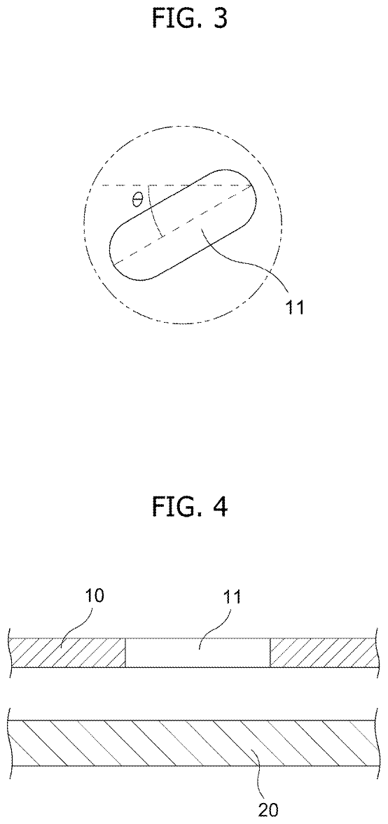

First, the structure of a drug capsule appearance inspection device according to an embodiment of the present invention will be described with reference to FIG. 1 to FIG. 6 as follows.

An inspection device according to an embodiment of the present invention includes: a guide plate 10 having a plurality of capsule accommodating grooves 11 formed therein so that drug capsules P can be accommodated; and a bottom friction surface 20 that allows the drug capsules P to rotate by friction when the guide plate 10 moves horizontally.

Herein, it can be seen that the capsule accommodating grooves 11 are provided in an inclined shape of a predetermined angle 8.

The operational effect involved in the operation of the capsule appearance inspection device according to the present invention in the above configuration will be described.

In the inspection device according to the present invention, the appearance inspection is made in a state in which the drug capsules P are accommodated in the capsule accommodating grooves 11 of the guide plate 10 having a rectangular plate shape.

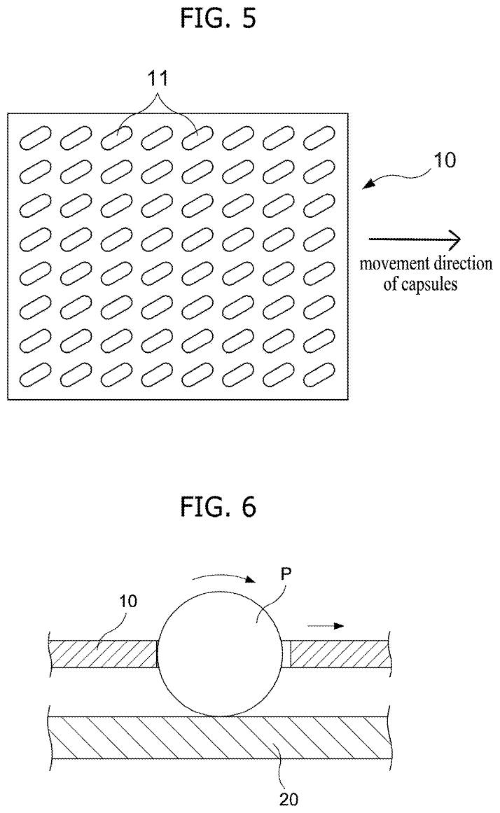

That is, when the guide plate 10 in which the plurality of drug capsules P is accommodated is moved in one direction as shown in FIG. 5, the drug capsules P are rotated slowly by friction with the bottom friction surface 20 as shown in FIG. 6.

Accordingly, it is possible to carry out the appearance inspection of the drug capsules P that rotate in the state accommodated in the respective capsule accommodating grooves 11.

It should be understood that the capsule accommodating grooves 11 formed in the guide plate 10 may have various sizes depending on the size of capsules, and the inclination angle of the capsule accommodating grooves 11 may be formed at various angles.

Therefore, the capsule appearance inspection device of the present invention having a simplified structure as described above exhibits the effect of saving costs and enabling faster and more efficient appearance inspection of the drug capsule capsules.

In particular, by forming the capsule accommodating grooves at a certain angle, it provides the advantage that rotation according to the friction with the bottom friction surface can be made more smoothly.

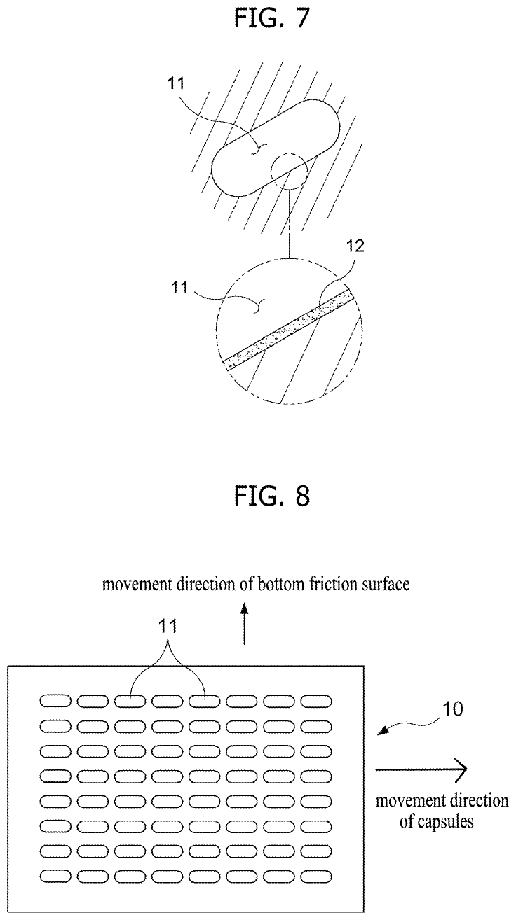

Meanwhile, FIG. 7 shows a configuration according to another embodiment of the present invention, wherein a friction reducing coating layer 12 for reducing friction with respect to the drug capsules P is coated on the inner surfaces of the capsule accommodating grooves 11.

Herein, the friction reducing coating layer 12 is formed of a basic mixed composition of calcium oxide, sodium hyaluronate, polyoxyethylene alkyl ether, gallium arsenide, and ethylene resin, and pyrdioxal phosphate and magnesium hypophosphite components may be additionally added to improve functionality if necessary.

That is, at this time, it is preferable to mix each component in a ratio of 10-30 wt % of calcium oxide, 5-20 wt % of sodium hyaluronate, 10-25 wt % of polyoxyethylene alkyl ether, 1-15 wt % of gallium arsenide, 10-30 wt % of ethylene resin, 1-10 wt % of pyrdioxal phosphate, and 1-10 wt % of magnesium hypophosphite.

When such a configuration is achieved, the drug capsules P can rotate more easily due to the friction reducing coating layer 12.

In particular, since calcium oxide and sodium hyaluronate are mixed in the composition of the friction reducing coating layer 12, damage to the capsules due to surface contact is prevented. Polyoxyethylene alkyl ether improves the durability of the coating, and gallium arsenide can improve the lubrication function through the catalytic action of ethylene resin. In addition, the additionally added pyrdioxal phosphate functions to prevent discoloration and oxidation of the friction reducing coating layer 12, and magnesium hypophosphite exhibits an advanced operational effect of preventing cracks by improving the coating density.

FIG. 8 shows a capsule appearance inspection configuration according to still another embodiment of the present invention, wherein it can be seen that a lower bottom friction surface 20 is formed in a movable structure such as a drive belt so that the horizontal movement of the bottom friction surface 20 is made at an angle different from the moving direction of the guide plate 10.

As described above, the bottom friction surface 20 moves horizontally together, exhibiting the advantage of more efficient capsule inspection.

Although specific embodiments of the present invention have been described and illustrated in the above, it is obvious that the capsule appearance inspection device structure of the present invention can be implemented with various modifications by those skilled in the art.

However, such modified embodiments should not be individually understood departing from the spirit or scope of the present invention, and such modified embodiments should be included within the scope of the appended claims of the present invention.

The present invention can reduce the cost by making a simple structure in the field of drug capsule manufacturing, and the appearance inspection of the drug capsules can be made more rapidly and efficiently. In particular, by forming the capsule accommodating grooves at a certain angle, it is expected that rotation according to the friction with the bottom friction surface can be made more smoothly.

What is claimed is:

1. A drug capsule appearance inspection device, comprising:
a guide plate (10) having a plurality of capsule accommodating grooves (11) formed therein for accommodating drug capsules (P); and
a bottom friction surface (20) that allows the drug capsules (P) to rotate by friction when the guide plate (10) moves in a horizontal movement.

2. The drug capsule appearance inspection device according to claim 1, wherein
the capsule accommodating grooves (11) have an inclination of a predetermined angle (θ).

3. The drug capsule appearance inspection device according to claim 1, wherein the lower friction surface (20) is driven at a predetermined angle with respect to a direction of the horizontal movement of the guide plate (10) in a direction different from the direction of horizontal movement of the guide plate (10).

4. The drug capsule appearance inspection device according to claim 1, wherein an inner surface of each of the capsule accommodating grooves (11) is coated with a friction reducing coating layer (12) for reducing friction with respect to the drug capsules (P), and the friction reducing coating layer (12) consists of a mixed composition of calcium oxide, sodium hyaluronate, polyoxyethylene alkyl ether, gallium arsenide, and ethylene resin.

5. The drug capsule appearance inspection device according to claim 4, wherein the friction reducing coating layer (12) additionally contains pyrdioxal phosphate and magnesium hypophosphite.
